(19) United States
(12) Patent Application Publication
(10) Pub. No.: US 2016/0354622 A1
(43) Pub. Date: Dec. 8, 2016

(54) GAS DETECTION AND FIRE SUPPRESSION SYSTEM FOR HYDROGEN SALT CAVERN

(71) Applicant: Air Liquide Large Industries U.S. LP, Houston, TX (US)

(72) Inventor: Phillip JAMES, Pearland, TX (US)

(21) Appl. No.: 14/753,914

(22) Filed: Jun. 29, 2015

Related U.S. Application Data
(63) Continuation of application No. 14/732,021, filed on Jun. 5, 2015.

(51) Int. Cl. A62C 3/00; A62C 37/36; A62C 3/02

(52) U.S. Cl. CPC A62C 3/002; A62C 3/0221; A62C 37/36

(57) ABSTRACT

A gas detection and fire suppression system is proposed that includes at least one hydrogen gas detector located proximate to a hydrogen salt cavern wellhead, the at least one hydrogen gas detector configured to generate a signal upon detecting a concentration of hydrogen gas above a predetermined threshold. The system also includes at least one automatic self oscillating fire monitor located proximate to the hydrogen salt cavern wellhead, the at least one automatic self oscillating fire monitor configured to activate upon the receive a signal from the at least one hydrogen gas detector. And the system includes an alarm, wherein the alarm is configured to activate upon the receipt of the signal from the at least one hydrogen gas detector.

### CROSS REFERENCE TO RELATED APPLICATIONS

This application is a continuation of U.S. patent application Ser. No. 14/732,021 filed Jun. 5, 2015, the entire contents of which are incorporated herein by reference.

### BACKGROUND

A gas release and/or a fire as the result of a high pressure leak from an underground storage cavern has the potential for profound loss of property and productivity, as well as the devastating potential for loss of life. Such a gas release, or fire, may be detected and extinguished by the use of a fire and gas detection system installed at the underground storage cavern installation. The monitoring the area around the installation for gas leaks and fires is critical for the safe operation of the underground storage cavern. A fire and gas detection system may provide ambient monitoring for the specific gases stored in the cavern in addition to fixed firefighting equipment that can be activated automatically based on the gas detection system in addition to manually activated

### SUMMARY

A gas detection and fire suppression system is proposed that includes at least one hydrogen gas detector located proximate to a hydrogen salt cavern wellhead, the at least one hydrogen gas detector configured to generate a signal upon detecting a concentration of hydrogen gas above a predetermined threshold. The system also includes at least one automatic self oscillating fire monitor located proximate to the hydrogen salt cavern wellhead, the at least one automatic self oscillating fire monitor configured to activate upon the receipt of a signal from the at least one hydrogen gas detector. And the system includes an alarm, wherein the alarm is configured to activate upon the receipt of the signal from the at least one hydrogen gas detector.

### BRIEF DESCRIPTION OF THE DRAWINGS

For a further understanding of the nature and objects for the present invention, reference should be made to the following detailed description, taken in conjunction with the accompanying drawing, in which like elements are given the same or analogous reference numbers and wherein:

FIG. 1 illustrates a schematic representation of one embodiment of the present invention.

FIG. 2 illustrates a schematic representation of one embodiment of the present invention.

### DESCRIPTION OF PREFERRED EMBODIMENTS

Illustrative embodiments of the invention are described below. While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

High pressure gases, such as but not limited to nitrogen, air, carbon dioxide, hydrogen, helium, and argon, are stored in caverns, whether leached in salt formations or created by hard rock mining. These cavern installations contain multiple leak locations which need to be monitored to minimize the potential of leaks which could result in gas releases and/or fires. For the purpose of this invention, the definition of high pressure is defined as a pressure at or above 10 atmospheres.

There is a potential for leaks to atmosphere resulting in gas releases and/or fires from an underground storage cavern system due to the number of flanges in the installation. In order to minimize the potential and/or impact of gas leaks, the area around the cavern installation should be monitored by a fire and gas detection system. The fire and gas detection system will provide ambient monitoring for the specific gases stored in the cavern in addition to fixed firefighting equipment that can be activated automatically based on the gas detection system in addition to manually activated.

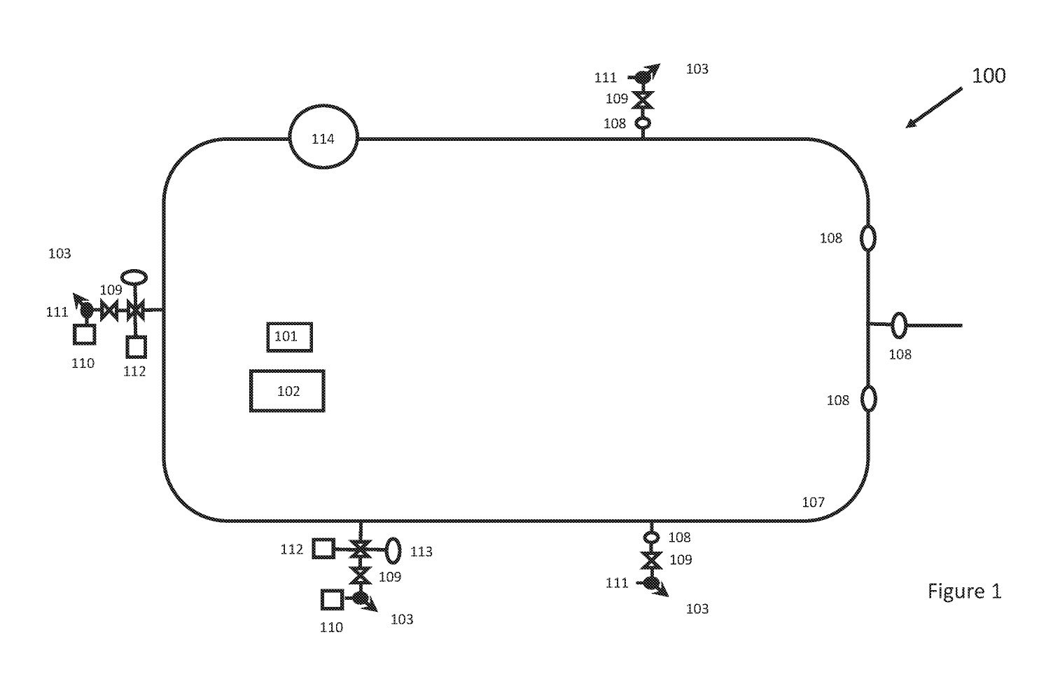

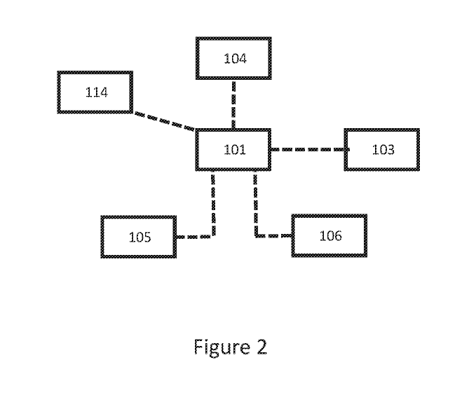

Turning now to FIGS. 1 and 2, the fire and gas detection system 100 will consist of a specific gas analyzer 101 at the cavern wellhead 102, automatic and/or remote activated self oscillating fire monitor(s) 103 at the cavern wellhead, and additional local activated fire monitor(s) 103 for the remaining surface facility equipment. The gas analyzer 101 will provide alarm(s) 104 if a gas leak is detected which could also activate 105 the automatic fire monitor(s) 103. Based on the alarm(s) 104, the automatic fire monitor(s) 103 could be activated remotely 106 if necessary. The additional local activated fire monitor(s) 103 would provide fire water for the surface facility equipment in case of a gas leak being detected. An underground fire water piping ring (FW ring) 107 with post indicator valves (PIV) 108 would provide the firewater to the monitors 103 as necessary.

The automatic 105 and/or remote activated 106 self oscillating fire monitor installations would consist of a solenoid activated valve with vault (SOV) 113, a pressure switch (PS) 112 to activate the solenoid valve, a manual butterfly valve (BV) 109, a self-oscillating accessory (SO) 110, and a fire monitor with adjustable nozzle (FM) 111. The pressure switch 112 would receive an indication from the gas analyzer(s) 101 or a remote panel 106 to open the solenoid valve 113 to begin flowing water from the fire monitor 111. The self oscillating accessory 110 would direct the fire water at the cavern wellhead 102 and surrounding area.

The local activated 105 fire monitors 103 would consist of a post indicator valve (PIV), manual butterfly valve (BV) 109, and a fire monitor with adjustable nozzle (FM) 111. The local activated 105 fire monitors 103 would be manually activated by verifying that the post indicator valve 108 is open and opening the butterfly valve 109. The nozzle 111 would be able to be manually oscillated to direct water at the surface piping and equipment as necessary.

A gas detection and fire suppression system is proposed that includes at least one hydrogen gas detector 102 located proximate to a hydrogen salt cavern wellhead 102, the at least one hydrogen gas detector 102 configured to generate a signal upon detecting a concentration of hydrogen gas above a predetermined threshold. The system also includes at least one automatic self oscillating fire monitor 103 located proximate to the hydrogen salt cavern wellhead 102, the at least one automatic self oscillating 110 fire monitor configured to activate upon the receipt of a signal from the at least one hydrogen gas detector 102. And the system includes an alarm, wherein the alarm 104 is configured to activate upon the receipt of the signal from the at least one hydrogen gas detector 102.

In addition, the gas detection and fire suppression system may include fixed firefighting equipment 114 at the perimeter of an area containing surface facility equipment associated with the hydrogen salt cavern wellhead 102. The surface facility equipment 114 may include a control building, maintenance/storage building, tanks, piping, valves, transformers, breakers, injection compressor, and hydrogen dryer. The fixed firefighting equipment 114 may be provided water from a pressurized firewater ring 107. The fixed firefighting equipment 114 may be activated automatically upon the receipt of a signal form the at least one hydrogen gas detector 102, or they may be activated manually 105, or remotely 106.

A gas detection and fire suppression method is proposed that includes detecting ambient hydrogen gas in an area proximate to a hydrogen salt cavern wellhead, by means of at least one hydrogen gas detector. The method also includes signaling at least one automatic self oscillating fire monitor in an area proximate to the hydrogen salt cavern wellhead, by means of a communicating means configured for communicating between the at least one hydrogen gas detector and the at least one automatic self oscillating fire monitor. And the method includes activating an alarm by means of a communication means configured for communicating between the at least one hydrogen gas detector and the alarm.

1. A gas detection and fire suppression system, comprising;
at least one hydrogen gas detector located proximate to a hydrogen salt cavern wellhead, the at least one hydrogen gas detector configured to generate a signal upon detecting a concentration of ambient hydrogen gas above a predetermined threshold,
at least one automatic self oscillating fire monitor located proximate to the hydrogen salt cavern wellhead, the at least one automatic self oscillating fire monitor configured to activate upon the receive a signal from the at least one hydrogen gas detector, and
an alarm, wherein the alarm is configured to activate upon the receipt of the signal from the at least one hydrogen gas detector.

2. The gas detection and fire suppression system of claim 1, further comprising fixed firefighting equipment at the perimeter of an area containing surface facility equipment associated with the hydrogen salt cavern wellhead.

3. The gas detection and fire suppression system of claim 2, wherein the surface facility equipment is selected from the group consisting of a control building, maintenance/storage building, tanks, piping, valves, transformers, breakers, injection compressor, and hydrogen dryer.

4. The gas detection and fire suppression system of claim 2, wherein said fixed firefighting equipment are provided water from a pressurized firewater ring.

5. The gas detection and fire suppression system of claim 2, wherein said fixed firefighting equipment are activated automatically upon the receipt of a signal form the at least one hydrogen gas detector.

6. The gas detection and fire suppression system of claim 2, wherein said fixed firefighting equipment are activated manually.

7. The gas detection and fire suppression system of claim 6, wherein said fixed firefighting equipment are remotely activated.

8. The gas detection and fire suppression system of claim 1, wherein the at least one automatic self oscillating fire monitor is activated automatically upon the receipt of the signal form the at least one hydrogen gas detector.

9. A gas detection and fire suppression method, comprising;
detecting ambient hydrogen gas in an area proximate to a hydrogen salt cavern wellhead, by means of at least one hydrogen gas detector, and
signaling at least one automatic self oscillating fire monitor in an area proximate to the hydrogen salt cavern wellhead, by means of a communicating means configured for communicating between the at least one hydrogen gas detector and the at least one automatic self oscillating fire monitor, and
activating an alarm by means of a communication means configured for communicating between the at least one hydrogen gas detector and the alarm.

10. The gas detection and fire suppression method of claim 9, further comprising activating fixed firefighting equipment at the perimeter of an area containing surface facility equipment associated with the hydrogen salt cavern wellhead automatically upon the receipt of a signal form the at least one hydrogen gas detector

11. The gas detection and fire suppression method of claim 10, further comprising providing said fixed firefighting equipment with water from a pressurized firewater ring.
